(19) United States
(12) Patent Application Publication
(10) Pub. No.: US 2024/0254828 A1
(43) Pub. Date: Aug. 1, 2024

(54) TWO-PIECE FRAME ASSEMBLY FOR FENESTRATION ASSEMBLIES

(71) Applicant: Andersen Corporation, Bayport, MN (US)

(72) Inventors: Todd Bruchu, Lake Elmo, MN (US); Duane Fier, Hudson, WI (US)

(21) Appl. No.: 18/399,110

(22) Filed: Dec. 28, 2023

Related U.S. Application Data
(60) Provisional application No. 63/441,303, filed on Jan. 26, 2023.

(51) Int. Cl. E06B 3/22

(52) U.S. Cl. CPC E06B 3/22

(57) ABSTRACT

Embodiments herein relate to multi-piece frame elements for fenestration assemblies. In an embodiment, a fenestration assembly is included having a fenestration frame. The fenestration frame can include an exterior subunit. The exterior subunit can define a receiving channel. The fenestration frame can also include an interior subunit, wherein the interior subunit fits within the receiving channel. the interior subunit can include particles and/or fibers and a polymer resin. In some embodiments the exterior subunit can be a pultrusion while the interior subunit can be an extrusion. Other embodiments are also included herein.

This application claims the benefit of U.S. Provisional Application No. 63/441,303, filed Jan. 26, 2023, the content of which is herein incorporated by reference in its entirety.

### FIELD

Embodiments herein relate to frames and frame elements for fenestration assemblies. Specifically, embodiments herein relate to multi-piece frame elements.

### BACKGROUND

Fenestration units can include windows, patio doors, entry doors, and the like. Such fenestration units typically include frame members, such as sills, jambs, mull posts and the like. In some examples, frame members may be made with solid wood that, in some cases, may also include some type of cladding material. However, solid wood frame members may be more susceptible to rot than other materials, especially at the lower corners. As such, sometimes synthetic materials are used for frame members. However, variation in interior and exterior weather conditions can lead to thermal bowing of some synthetic frame parts.

### SUMMARY

Embodiments herein relate to multi-piece frame elements for fenestration assemblies. In a first aspect, a fenestration assembly can be included having a fenestration frame. The fenestration frame can include an exterior subunit. The exterior subunit can define a receiving channel. The fenestration frame can further include an interior subunit, wherein the interior subunit fits within the receiving channel. The interior subunit can include particles and/or fibers, and a polymer resin.

In a second aspect, in addition to one or more of the preceding or following aspects, or in the alternative to some aspects, the interior subunit further can include a tongue.

In a third aspect, in addition to one or more of the preceding or following aspects, or in the alternative to some aspects, the tongue engages the receiving channel.

In a fourth aspect, in addition to one or more of the preceding or following aspects, or in the alternative to some aspects, the receiving channel surrounds the tongue on at least three sides.

In a fifth aspect, in addition to one or more of the preceding or following aspects, or in the alternative to some aspects, the exterior subunit can include a first projection, and a second projection, wherein the first projection and the second projection extend within the receiving channel from opposite sides of the receiving channel.

In a sixth aspect, in addition to one or more of the preceding or following aspects, or in the alternative to some aspects, the tongue can include a first recess, wherein the first recess can be configured to accept the first projection, and a second recess, wherein the second recess can be configured to accept the second projection.

In a seventh aspect, in addition to one or more of the preceding or following aspects, or in the alternative to some aspects, the fenestration frame further can include an adhesive, wherein the adhesive can be disposed between a surface of the receiving channel and a surface of a distal end of a tongue, thereby coupling the tongue within the receiving channel.

In an eighth aspect, in addition to one or more of the preceding or following aspects, or in the alternative to some aspects, the adhesive can be disposed between an exterior most surface of the receiving channel and a surface of an exterior most surface of the tongue.

In a ninth aspect, in addition to one or more of the preceding or following aspects, or in the alternative to some aspects, the adhesive can be a structural adhesive.

In a tenth aspect, in addition to one or more of the preceding or following aspects, or in the alternative to some aspects, the adhesive can include a silicone adhesive.

In an eleventh aspect, in addition to one or more of the preceding or following aspects, or in the alternative to some aspects, wherein opposite lateral sides of the exterior subunit that define the receiving channel do not have the adhesive on them.

In a twelfth aspect, in addition to one or more of the preceding or following aspects, or in the alternative to some aspects, the adhesive can have a thickness of at least 0.03 inches and not more than 0.06 inches.

In a thirteenth aspect, in addition to one or more of the preceding or following aspects, or in the alternative to some aspects, the adhesive can have a thickness of at least 0.04 inches and not more than 0.05 inches.

In a fourteenth aspect, in addition to one or more of the preceding or following aspects, or in the alternative to some aspects, the fenestration frame further can include a connector, wherein the connector extends through a portion of the exterior subunit and into a portion of the interior subunit.

In a fifteenth aspect, in addition to one or more of the preceding or following aspects, or in the alternative to some aspects, the connector allows a limited degree of independent movement of the exterior subunit relative to the interior subunit.

In a sixteenth aspect, in addition to one or more of the preceding or following aspects, or in the alternative to some aspects, the connector extends through a lateral portion of the exterior subunit and into a lateral portion of the interior subunit.

In a seventeenth aspect, in addition to one or more of the preceding or following aspects, or in the alternative to some aspects, the connector can be a staple.

In an eighteenth aspect, in addition to one or more of the preceding or following aspects, or in the alternative to some aspects, the exterior subunit exhibits less thermal expansion than the interior subunit.

In a nineteenth aspect, in addition to one or more of the preceding or following aspects, or in the alternative to some aspects, the exterior subunit exhibits thermal expansion of less than 0.104 inches in response to a temperature change of 90 degrees Fahrenheit over a length of 96 inches.

In a twentieth aspect, in addition to one or more of the preceding or following aspects, or in the alternative to some aspects, the interior subunit exhibits thermal expansion of less than 0.259 inches in response to a temperature change of 20 degrees Fahrenheit over a length of 96 inches.

In a twenty-first aspect, in addition to one or more of the preceding or following aspects, or in the alternative to some aspects, the particles and/or fibers can include at least 1 wt. % wood particles.

In a twenty-second aspect, in addition to one or more of the preceding or following aspects, or in the alternative to some aspects, the particles and/or fibers can include at least 5 wt. % wood particles.

In a twenty-third aspect, in addition to one or more of the preceding or following aspects, or in the alternative to some aspects, the particles and/or fibers can include at least 15 wt. % wood particles.

In a twenty-fourth aspect, in addition to one or more of the preceding or following aspects, or in the alternative to some aspects, the particles and/or fibers can include wood particles and glass fibers.

In a twenty-fifth aspect, in addition to one or more of the preceding or following aspects, or in the alternative to some aspects, an outer portion of the exterior subunit can be a different color than an outer portion of the interior subunit.

In a twenty-sixth aspect, in addition to one or more of the preceding or following aspects, or in the alternative to some aspects, wherein a proximal portion of the receiving channel can be defined by a body member, and wherein a distal portion of the receiving channel can be defined between a first extension and a second extension.

In a twenty-seventh aspect, in addition to one or more of the preceding or following aspects, or in the alternative to some aspects, the exterior subunit can include a body member, a first extension, and a second extension.

In a twenty-eighth aspect, in addition to one or more of the preceding or following aspects, or in the alternative to some aspects, a first gap can be defined between a portion of the body member and the first extension, and a second gap can be defined between a portion of the body member and the second extension, and wherein the first gap and the second gap can be disposed on opposite sides of the receiving channel.

In a twenty-ninth aspect, in addition to one or more of the preceding or following aspects, or in the alternative to some aspects, the first extension can include a first projection, the second extension can include a second projection, and wherein the first projection and the second projection extend within the receiving channel from opposite sides of the receiving channel.

In a thirtieth aspect, in addition to one or more of the preceding or following aspects, or in the alternative to some aspects, the first projection can be offset from the second projection.

In a thirty-first aspect, in addition to one or more of the preceding or following aspects, or in the alternative to some aspects, a proximal portion of the receiving channel can be defined by a portion of the body member and a portion of the first extension and a distal portion of the receiving channel can be defined between the first extension and the second extension.

In a thirty-second aspect, in addition to one or more of the preceding or following aspects, or in the alternative to some aspects, a gap can be defined between a portion of the body member and the second extension.

In a thirty-third aspect, in addition to one or more of the preceding or following aspects, or in the alternative to some aspects, the first extension extends at least 50% of the length of the receiving channel defined by the body member and the second extension.

In a thirty-fourth aspect, in addition to one or more of the preceding or following aspects, or in the alternative to some aspects, the first extension extends at least 75% of the length of the receiving channel defined by the body member and the second extension.

In a thirty-fifth aspect, in addition to one or more of the preceding or following aspects, or in the alternative to some aspects, the first extension extends at least 90% of the length of the receiving channel defined by the body member and the second extension.

In a thirty-sixth aspect, in addition to one or more of the preceding or following aspects, or in the alternative to some aspects, the first extension and the second extension terminate at the same distance away from a proximal surface of the receiving channel.

In a thirty-seventh aspect, in addition to one or more of the preceding or following aspects, or in the alternative to some aspects, the first extension and the second extension have different lengths.

In a thirty-eighth aspect, in addition to one or more of the preceding or following aspects, or in the alternative to some aspects, a cross-section of the exterior subunit can have at least one axis of symmetry.

In a thirty-ninth aspect, in addition to one or more of the preceding or following aspects, or in the alternative to some aspects, a cross-section of the interior subunit can have at least one axis of symmetry.

In a fortieth aspect, in addition to one or more of the preceding or following aspects, or in the alternative to some aspects, a cross-section of the exterior subunit does not have an axis of symmetry.

In a forty-first aspect, in addition to one or more of the preceding or following aspects, or in the alternative to some aspects, a cross-section of the interior subunit does not have an axis of symmetry.

In a forty-second aspect, in addition to one or more of the preceding or following aspects, or in the alternative to some aspects, the fenestration frame further can include a fastener, wherein the fastener extends through a portion of the exterior subunit, through a portion of the interior subunit, and into a portion of a structure defining a rough opening.

In a forty-third aspect, in addition to one or more of the preceding or following aspects, or in the alternative to some aspects, the fastener can be a screw.

In a forty-fourth aspect, in addition to one or more of the preceding or following aspects, or in the alternative to some aspects, the fenestration frame can include a first side jamb, a second side jamb, a head jamb, a mull post, and a sill.

In a forty-fifth aspect, in addition to one or more of the preceding or following aspects, or in the alternative to some aspects, the exterior subunit can be pultrusion and the interior subunit can be an extrusion.

In a forty-sixth aspect, in addition to one or more of the preceding or following aspects, or in the alternative to some aspects, the exterior subunit can be an extrusion and the interior subunit can be an extrusion, wherein the interior subunit can be formed with a different composition than the exterior subunit.

In a forty-seventh aspect, a fenestration assembly can be included having a fenestration frame. The fenestration frame can include an exterior extrusion and an interior subunit. The exterior extrusion can define a receiving channel. The exterior extrusion can include at least 30 wt. % glass fibers and a first polymer resin. The interior subunit fits within the receiving channel. The interior subunit can include particles and/or fibers and a second polymer resin.

In a forty-eighth aspect, in addition to one or more of the preceding or following aspects, or in the alternative to some aspects, the first polymer resin can include polyvinylchloride.

In a forty-ninth aspect, in addition to one or more of the preceding or following aspects, or in the alternative to some aspects, the second polymer resin can include polyvinylchloride.

In a fiftieth aspect, in addition to one or more of the preceding or following aspects, or in the alternative to some aspects, the receiving channel can include at least 40 wt. % glass fibers.

In a fifty-first aspect, a fenestration assembly can be included having a jamb. The jamb can include an exterior subunit defining a receiving channel, an interior subunit. The jamb can include an interior subunit that fits within the receiving channel. The interior subunit can include particles and/or fibers, and a polymer resin.

In a fifty-second aspect, a fenestration assembly can be included having a jamb. The jamb can include an exterior extrusion, the exterior extrusion defining a receiving channel. The exterior extrusion can include at least 30 wt. % glass fibers and a first polymer resin. The jamb can include an interior subunit, wherein the interior subunit fits within the receiving channel. The interior subunit can include particles and/or fibers, and a second polymer resin.

In a fifty-third aspect, a fenestration assembly can be included having a mull post. The mull post can include an exterior subunit. The exterior subunit can define a receiving channel. The mull post can include an interior subunit. The interior subunit fits within the receiving channel. The interior subunit can include particles and/or fibers, and a polymer resin.

In a fifty-fourth aspect, a fenestration assembly can be included having a mull post. The mull post can include an exterior extrusion. The exterior extrusion can define a receiving channel. The exterior extrusion can include at least 30 wt. % glass fibers and a first polymer resin. The mull post can include an interior subunit. The interior subunit fits within the receiving channel. The interior subunit can include particles and/or fibers, and a second polymer resin.

In a fifty-fifth aspect, a door assembly can be included having a fenestration frame. The fenestration frame can include an exterior subunit. The exterior subunit can define a receiving channel. The fenestration frame can include an interior subunit. The interior subunit can fit within the receiving channel. The interior subunit can include particles and/or fibers, and a polymer resin. The door assembly can further include a door.

In a fifty-sixth aspect, in addition to one or more of the preceding or following aspects, or in the alternative to some aspects, the door can be at least partially surrounded by the fenestration frame.

In a fifty-seventh aspect, a door assembly can be included having a door, a side lite, and a mull post, wherein the mull post can be disposed between the door and the side lite. The mull post can include an exterior subunit. The exterior subunit can define a receiving channel. The mull post can include an interior subunit. The interior subunit can fit within the receiving channel. the interior subunit can include particles and/or fibers, and a polymer resin.

In a fifty-eighth aspect, in addition to one or more of the preceding or following aspects, or in the alternative to some aspects, the door can be at least partially surrounded by the mull post.

In a fifty-ninth aspect, a fenestration frame can be included having a series of at least three dual component structural members that each can include a first component and a second component. The first component can include a fiber-reinforced polymeric material defining a receiving channel, the receiving channel being defined by a first side portion, a second side portion, and a base portion connecting the first side portion with the second side portion. The second component can include a particulate-filled polymeric material defining a tongue portion that engages the receiving channel of the first component to combine the first component and the second component into a structural member.

In a sixtieth aspect, in addition to one or more of the preceding or following aspects, or in the alternative to some aspects, the at least three structural members can be peripheral structural members and define an open area in between.

In a sixty-first aspect, in addition to one or more of the preceding or following aspects, or in the alternative to some aspects, the receiving channel surrounds the tongue portion on three sides.

In a sixty-second aspect, in addition to one or more of the preceding or following aspects, or in the alternative to some aspects, the first component can include a first projection and a second projection extending within the receiving channel from the first and second sides of the receiving channel.

In a sixty-third aspect, in addition to one or more of the preceding or following aspects, or in the alternative to some aspects, the tongue defines a first recess and a second recess on opposite sides of the tongue, wherein the first recess can be configured to accept the first projection and the second recess can be configured to accept the second projection.

In a sixty-fourth aspect, in addition to one or more of the preceding or following aspects, or in the alternative to some aspects, an adhesive can be disposed between a base of the receiving channel and an outer surface of a distal end of the tongue thereby coupling the tongue within the receiving channel.

In a sixty-fifth aspect, in addition to one or more of the preceding or following aspects, or in the alternative to some aspects, the adhesive can be a flexible sealant.

In a sixty-sixth aspect, in addition to one or more of the preceding or following aspects, or in the alternative to some aspects, the second component includes at least 30 wt. % wood particles.

In a sixty-seventh aspect, a fenestration frame can be included having a series of at least three dual component structural members that each can include a first component and a second component. The first component can include a metal structure defining a receiving channel. The receiving channel can be defined by a first side portion, a second side portion, and a base portion connecting the first side portion with the second side portion. The second component can include a polymeric material defining a tongue portion that engages the receiving channel of the first component to combine the first component and the second component into a structural member.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a simplified front elevation view of an entry door system in accordance with various embodiments herein.

FIG. 2 is a cross-sectional view of a jamb in accordance with various embodiments herein.

FIG. 3 is a cross-sectional view of an exterior jamb portion in accordance with various embodiments herein.

FIG. 4 is a cross-sectional view of an exterior jamb portion in accordance with various embodiments herein.

FIG. 5 is a cross-sectional view of an exterior jamb portion in accordance with various embodiments herein.

FIG. 6 is a cross-sectional view of an interior jamb portion in accordance with various embodiments herein.

FIG. 7 is a cross-sectional view of a mull post in accordance with various embodiments herein.

FIG. 8 is a cross-sectional view of an exterior mull portion in accordance with various embodiments herein.

FIG. 9 is a cross-sectional view of an exterior mull portion in accordance with various embodiments herein.

FIG. 10 is a cross-sectional view of an exterior mull portion in accordance with various embodiments herein.

FIG. 11 is a cross-sectional view of an interior mull portion in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, sometimes synthetic materials are used for frame members. However, variation in interior and exterior weather conditions can lead to thermal bowing of some synthetic frame parts. This is particularly true of some extrusions made with certain formulations of thermoplastic polymers. Generally, frame members are made with a one-piece design. However, one-piece frame designs can make it difficult to provide different interior and exterior material properties such as thermal expansion properties, surface appearances, and/or colors.

Included herein are various embodiments of a two-piece frame for fenestration assemblies. The two-piece frame can include an interior portion and an exterior portion. The interior portion can generally be on the interior side of the fenestration assembly (such as would be facing the interior of a structure into which the fenestration assembly is installed) and the exterior portion can generally be on the exterior side of the fenestration assembly (such as would be facing the exterior of a structure into which the fenestration assembly is installed). The two portions can be extruded, pultruded, or otherwise formed separately. The two portions can be assembled together prior to installation, such as during the manufacturing process of the fenestration assembly.

The two portions can be made of composite materials that are rot resistant and have desirable properties, such as a desired modulus of elasticity. In use, the materials of the two-piece frame can improve performance, enhance dimensional stability, and reduce thermal expansion of the frame components, which may otherwise lead to thermal bowing and/or other deformation. In some embodiments, two-piece frames herein can also offer thermal performance benefits, such as by providing a thermal break. Further, in some embodiments, the interior and exterior portions can have different surface properties (such as surface smoothness or texture) and/or colors from each other resulting in improved aesthetics for an installed assembly.

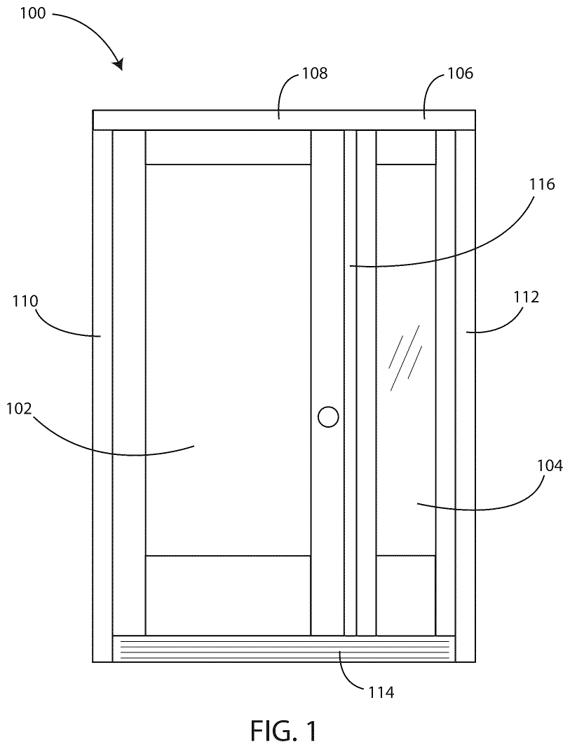

The embodiments of a fenestration frame disclosed herein can be used with various fenestration systems including, but not limited to, entry door systems, patio door systems, windows, and the like. Referring now to FIG. 1, a simplified front elevation view is shown of a fenestration assembly 100 in the form of an entry door in accordance with various embodiments herein. The fenestration assembly 100 can include an entry door 102 and a side light 104. The fenestration assembly 100 also includes a fenestration frame 106. The fenestration frame 106 can be disposed between a door 102 and a structure defining a rough opening.

The fenestration frame 106 can include a head jamb 108, a first side jamb 110, a second side jamb 112, and a sill 114. In various embodiments, the fenestration frame 106 also includes a mull post 116. The mull post 116 can be included between the entry door 102 and the side light 104. In various embodiments, the door 102 can be at least partially surrounded by the fenestration frame 106. In various embodiments, the door 102 can be adjacent to or otherwise at least partially surrounded by a mull post 116, such as along one side.

In various embodiments herein, the fenestration frame 106 can include an interior portion and an exterior portion. The two portions can be manufactured separately and then coupled prior to installation, such as during the manufacturing process. In some embodiments, the interior portion and the exterior portion can include different materials, such as different materials having different properties.

In some embodiments, the exterior portion can be a pultrusion or an extrusion. In some embodiments, the interior portion can be an extrusion. In some embodiments, the exterior portion can be formed of a material such that the exterior portion exhibits less thermal bowing than the interior portion. In some embodiments, the exterior portion can be formed of a material that has a lower coefficient of thermal expansion than the interior portion. In some embodiments, the interior portion can be formed of a material that is less expensive than the exterior portion. In some embodiments, the exterior portion can be a metal, such as aluminum, and the interior portion can be polymer or a polymer composite. In some embodiments, both the exterior portion and the interior portion can be composite, such as those described herein, but different composites from one another. In some embodiments, the outer surface of the exterior portion can be a different color than an outer surface of the interior portion. In some embodiments, the outer surface of the exterior portion can have a different surface texture than an outer surface of the interior portion.

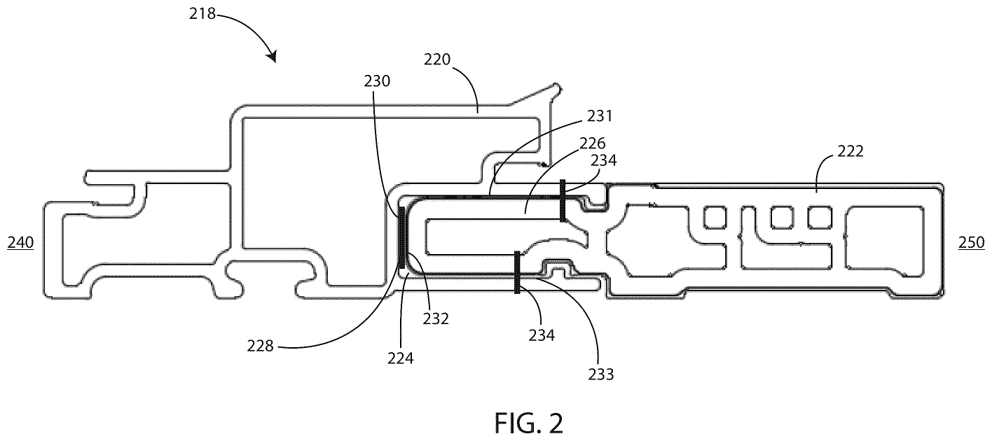

Referring now to FIG. 2, a cross-sectional view of a jamb 218 is shown in accordance with various embodiments herein. The jamb 218 shown in FIG. 2 can represent a cross-section of any of the jamb components shown in FIG. 1. However, jamb 218 is merely exemplary and various changes can be made to the same while still being consistent with the scope of embodiments herein. FIG. 2 shows the exterior side 240 (such as the exterior of a building or structure into which the fenestration is installed) as well as the interior side 250 (such as the interior of a building or structure into which the fenestration is installed).

The jamb 218 can include an exterior jamb portion 220 and an interior jamb portion 222. The exterior jamb portion 220 can define a receiving channel 224. The receiving channel 224 includes an inner surface portion 230 (or inner surface end portion). The inner surface portion 230 can be located at the end of the receiving channel 224 (such as the distal end of the channel, farthest away from the entrance to the channel). The receiving channel 224 can be defined by the inner surface portion 230 and the lateral sides 231, 233. The receiving channel 224 can be configured to accept or to accommodate a portion, such as the tongue 226, of the interior jamb portion 222. In some embodiments, the receiving channel 224 can be configured to surround (on one or both sides) at least about 10, 20, 30, 40, 50, 60, 70, 80, or 90 percent of the cross-sectional length or longest dimension in cross-section of the interior jamb portion 222, or an amount falling within a range between any of the foregoing. In many embodiments herein, the receiving channel 224 does not completely surround the interior jamb portion 222.

The interior jamb portion 222 can include a tongue 226. The tongue 226 includes a distal end 232. In some embodiments, the distal end 232 can be flat or can include a flat surface. In some embodiments, the distal end 232 can include rounded corners or edges.

The tongue 226 can be inserted into the receiving channel 224. An adhesive 228 can be disposed between the distal end 232 of the tongue 226 and the inner surface portion 230 of the receiving channel 224 thereby coupling the interior jamb portion 222 with the exterior jamb portion 220. In various embodiments, the adhesive 228 can be positioned at a centroid of the two-piece frame.

In various embodiments, the jamb 218 can also include one or more connectors 234, such as a mechanical connector or fastener. The connectors 234 can extend through a portion of the exterior jamb portion 220 and a portion of the interior jamb portion 222. The connectors 234 can secure the interior jamb portion 222 with the exterior jamb portion 220. The connectors 234 can be used to aid in the manufacturing process to keep the exterior and interior jamb portions in position with one another as the adhesive cures.

In various embodiments, the connectors 234 can still allow for a degree of independent movement of the exterior and interior jamb portions as opposed to a fastener that prevents any movement of the exterior and interior jamb portions. In some embodiments, the one or more connectors 234 can be in the form of staples. However, other types of fasteners can also be used for the connector 234. Thus, in some embodiments, an adhesive can be used with the distal most surface of the tongue 226 and a mechanical fastener can be used with the sides of the tongue 226 bordering the opposite lateral sides 231, 233 of the receiving channel 224.

In some embodiments, a cross-section of the exterior jamb portion 220, such as shown in FIG. 2, does not have an axis of symmetry or is asymmetric. In various embodiments, a cross-section of the interior jamb portion 222, such as shown in FIG. 2, does not have an axis of symmetry or is asymmetric. However, in other embodiments herein, either one or both of the exterior jamb portion 220 or the interior jamb portion 22 can have an axis of symmetry.

As shown in FIG. 2, the tongue 226 engages the receiving channel 224. In various embodiments, the receiving channel 224 surrounds the tongue 226 on at least three sides when the tongue 226 is disposed within the receiving channel 224, such as with inner surface portion 230 and the two lateral sides 231, 233. In various embodiments, the adhesive 228 can be disposed between the inner surface portion 230 of the receiving channel 224 and the outer surface of the distal end 232 of a tongue 226, thereby coupling the tongue 226 within the receiving channel 224. In various embodiments, the opposite lateral sides 231, 233 of the exterior jamb portion 220 that define the receiving channel 224 do not have adhesive on them or disposed between them and the tongue 226.

However, in some embodiments, the opposite lateral sides 231, 233 of the receiving channel 224 can also have adhesive on them and/or disposed between them and the tongue 226. In various embodiments, the adhesive 228 has a thickness of at least 0.04 inches and not more than 0.07 inches. In various embodiments, the adhesive 228 has a thickness of at least 0.05 inches and not more than 0.06 inches. In some embodiments, the adhesive 228 can be a structural adhesive. While not intending to be bound by theory, it is believed that the configuration shown in FIG. 2 can aid in preventing thermal bowing of the jamb 218.

In some embodiments, the exterior jamb portion 220 can include a first projection and a second projection (described further below). The projections can be configured to fit within corresponding recesses defined by the interior jamb portion 222 to further secure the exterior jamb portion 220 with the interior jamb portion 222. In some embodiments, the projections can hold the portions of the jamb together until an adhesive sets and/or mechanical connectors are inserted.

In various embodiments, the jamb 218 can include one or more fasteners. The fastener can extend through a portion of the exterior jamb portion, through a portion of the interior jamb portion, and into a portion of a structure defining a rough opening, such as to secure the jamb 218 to the structure. In various embodiments, the fastener can be a screw, a nail, a rivet, a bolt, or the like.

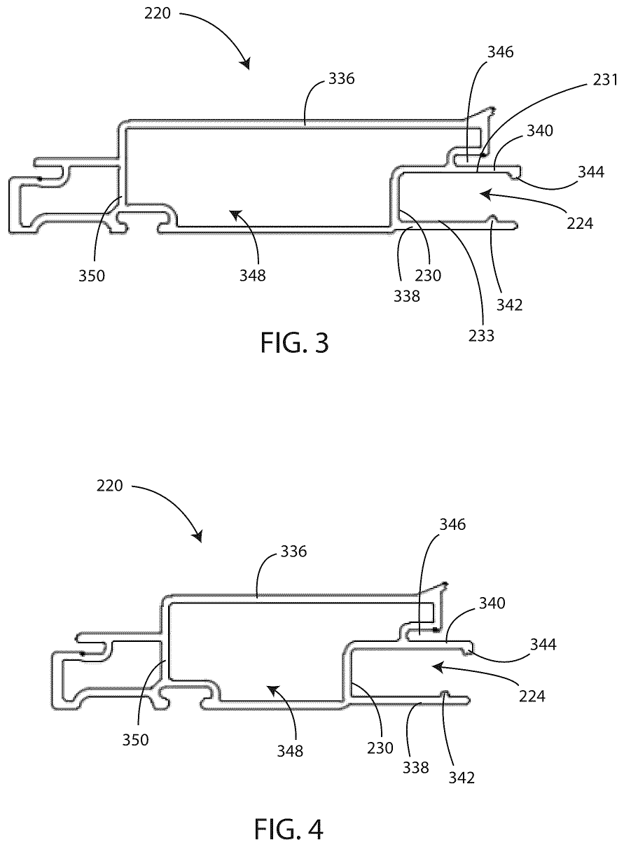

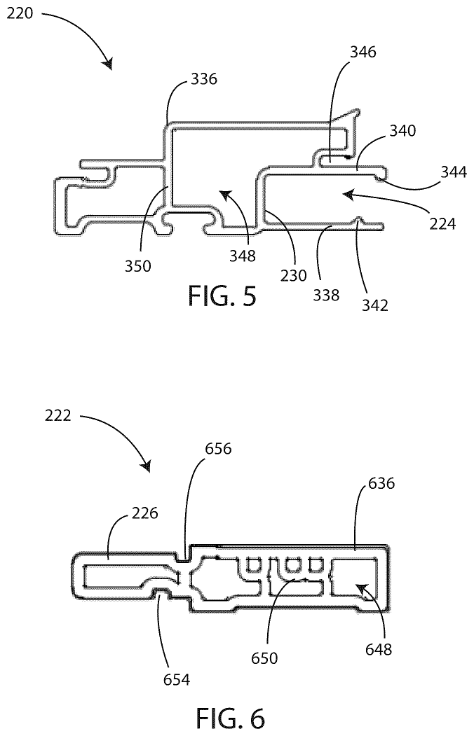

FIGS. 3-5 show cross-sectional views of various embodiments of exterior jamb portions 220. FIG. 3, FIG. 4, and FIG. 5 each show a cross-sectional view of an exterior jamb portion 220 according to various embodiments. The exterior jamb portion 220 defines a receiving channel 224. The exterior jamb portion 220 includes a body member 336. In some embodiments, the body member 336 can define an inner volume 348. In various embodiments, the body member 336 can also include one or more inner walls 350. In some embodiments, the one or more inner walls 350 can divide the inner volume 348 into a plurality of internal hollows.

The exterior jamb portion 220 includes a first extension 338 and a second extension 340. The first extension 338 and the body member 336 can define a portion of the receiving channel 224, such as the distal portion or inner most portion of the receiving channel 224 (or the portion closest to the exterior side of the fenestration). The first extension 338 and the second extension 340 can define a portion of the receiving channel 224 including the proximal portion thereof, or interior side portion (with respect to the fenestration), or outer most portion (with respect to the receiving channel itself) of the receiving channel 224, or channel entrance portion. In some embodiments, the first extension 338 and the second extension 340 are extensions from the body member 336 that do not enclose or form part of the inner volume 348.

In various embodiments, the first extension 338 can include a first projection 342, and the second extension 340 can include a second projection 344. When coupled with the interior jamb portion 222, the projections 342, 344 can be fit within recesses defined by the tongue 226 of the interior jamb portion 222. In some embodiments, the projections 342, 344 extend into the receiving channel 224. In some embodiments, the projections 342, 344 extend into the receiving channel 224 from opposite sides of the receiving channel 224. In various embodiments, the first projection 342 can be offset from a second projection 344, such that the first projection 342 is not directly across the receiving channel 224 from the second projection 344. In some embodiments, the projections 342, 344 extend in a direction perpendicular to a longitudinal axis of the extensions 338, 340. In some embodiments, one or both of the projections 342, 344 can be disposed at the end of the extensions 338, 340, such as the location of the second projection 344 in FIG. 3. In some embodiments, one or both of the projections 342, 344 can be disposed at locations that are inset from the ends of the extensions 338, 340, such as the location of the first projection in FIG. 3.

In some embodiments, the exterior jamb portion 220 defines a first gap 346. The first gap 346 can be external to the receiving channel 224. The first gap 346 can be defined between the second extension 340 and a portion of the body member 336. In various embodiments, the first gap 346 can allow the second extension 340 to flex or bend away from the receiving channel 224, such as to allow the tongue 226 to be inserted into the receiving channel 224 more easily.

In various embodiments, the first extension 338 extends a length at least 50% of the length of the receiving channel 224 defined by the body member 336 and the second extension 340. In various embodiments, the first extension 338 extends at least 75% of the length of the receiving channel 224 defined by the body member 336 and the second extension 340. In various embodiments, the first extension 338 extends at least 90% of the length of the receiving channel 224 defined by the body member 336 and the second extension 340. In various embodiments, the first extension 338 and a second extension 340 terminate at the same distance away from the inner surface portion 230 of the receiving channel 224. In various embodiments, the first extension 338 and a second extension 340 have different lengths.

FIG. 6 shows a cross-sectional view of an interior jamb portion 222 in accordance with various embodiments herein. The interior jamb portion 222 can include a body member 636. The body member 636 can define an inner volume 648. The body member can further include one or more inner walls 650. The inner walls 650 can divide or separate the inner volume 648 into a plurality of internal hollows.

The interior jamb portion 222 can include a tongue 226, such as a portion of the body member 636 that extends outward and is configured to be inserted into the receiving channel 224. The tongue 226 can be at least 10, 20, 30, 40, 50, 60, 70, 80, or 90 percent (or an amount falling within a range between any of the foregoing) of the overall cross-sectional length or length along the longest axis of the interior jamb portion 222 in cross section. While not intending to be bound by theory, the size of the tongue can impact the degree of thermal bowing of the jamb 218 herein. The tongue 226 can define a first recess 654 and a second recess 656. The first recess 654 can be on the opposite side of the tongue 226 from the second recess 656. In various embodiments, the first recess 654 can be configured to accept a first projection 342. In various embodiments, the second recess 656 can be configured to accept the second projection 344. In various embodiments, a cross-section of the interior jamb portion 222 does not have an axis of symmetry or is asymmetric.

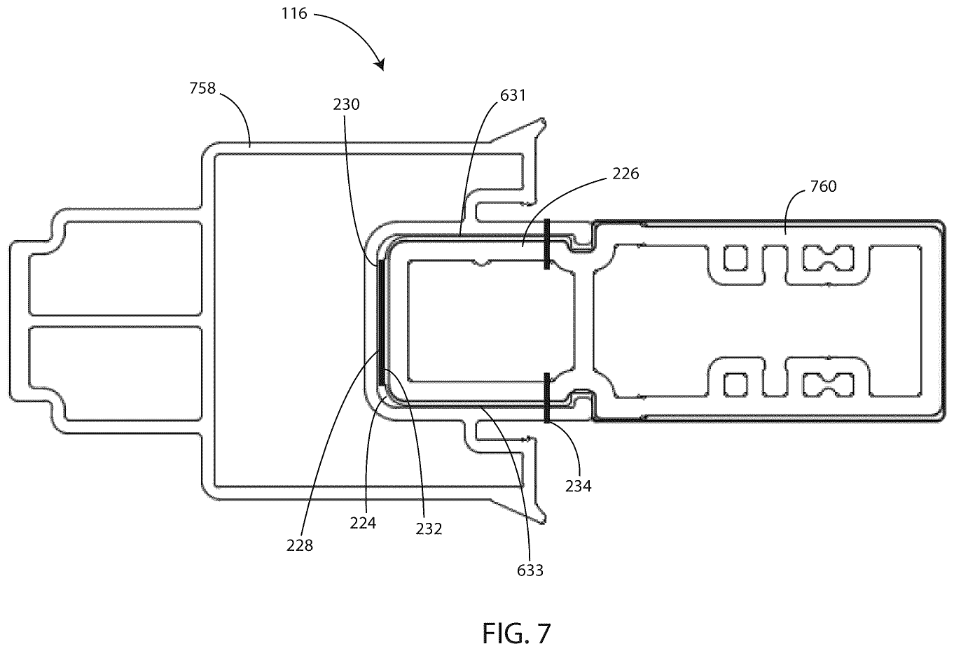

Two-piece frame configurations herein can be used for many different possible frame components. Referring now to FIG. 7, a cross-sectional view of a mull post 116 is shown in accordance with various embodiments herein. The mull post 116 shown in FIG. 7 can represent a cross-section of mull post 116 shown in FIG. 1.

The mull post 116 can include an exterior mull portion 758 and an interior mull portion 760. Similar to the jamb 218, the exterior mull portion 758 can define a receiving channel 224. The receiving channel 224 includes an inner surface portion 230. The inner surface portion 230 can be located at the distal end of the receiving channel 224. The receiving channel 224 can be defined by the inner surface portion 230 and the lateral sides 631, 633.

The interior mull portion 760 can include a tongue 226. The receiving channel 224 can be configured to accept or to accommodate a portion, such as the tongue 226, of the interior mull portion 760. The tongue 226 includes a distal end 232. In some embodiments, the distal end 232 can be flat or can include a flat surface. In some embodiments, the distal end 232 can include rounded corners or edges.

The tongue 226 can be inserted into the receiving channel 224. An adhesive 228 can be disposed between the distal end 232 of the tongue 226 and the inner surface portion 230 of the receiving channel 224 thereby coupling the interior mull portion 760 with the exterior mull portion 758.

In various embodiments, the mull post 116 can also include a connector 234, such as a mechanical connector. The connector 234 can extend through a portion of the exterior mull portion 758 and a portion of the interior mull portion 760. The connector 234 can secure the interior mull portion 760 with the exterior mull portion 758. In some embodiments, the connector 234 can be in the form of a staple. Other types of fasteners can also be used for the connector 234.

In various embodiments, a cross-section of the exterior mull portion 758, such as shown in FIG. 7, has one or at least one axis of symmetry. In various embodiments, a cross-section of the interior mull portion 760, such as shown in FIG. 7, has one or at least one axis of symmetry.

In various embodiments, the tongue 226 engages the receiving channel 224. In various embodiments, the receiving channel 224 surrounds the tongue 226 on at least three sides, when the tongue 226 is disposed within the receiving channel 224, such as with the inner surface portion 230 and the lateral sides 631, 633. In various embodiments, the adhesive 228 can be disposed between an inner surface portion 230 of the receiving channel 224 and the outer surface of the distal end 232 of the tongue 226, thereby coupling the tongue 226 within the receiving channel 224. In various embodiments, the opposite lateral sides 631, 633 of the exterior mull portion 758 that define the receiving channel 224 do not have adhesive on them or between them and the tongue 226. In various embodiments, the adhesive 228 has a thickness of at least 0.04 inches and not more than 0.07 inches. In various embodiments, the adhesive 228 has a thickness of at least 0.05 inches and not more than 0.06 inches.

In various embodiments, the exterior mull portion 758 can include a first projection and a second projection. The projections can be configured to fit in recesses defined by the interior mull portion 760 to further secure the exterior mull portion 758 with the interior mull portion 760.

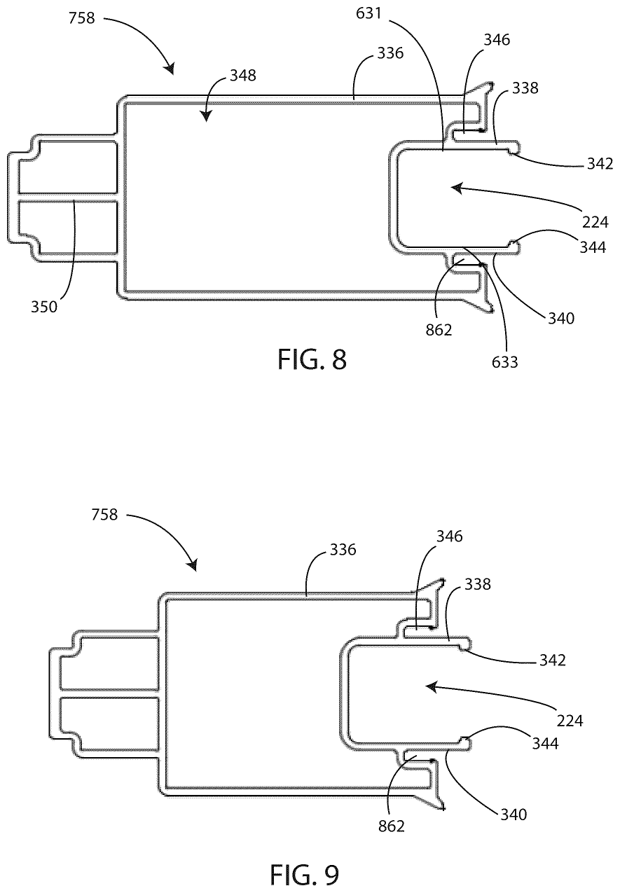

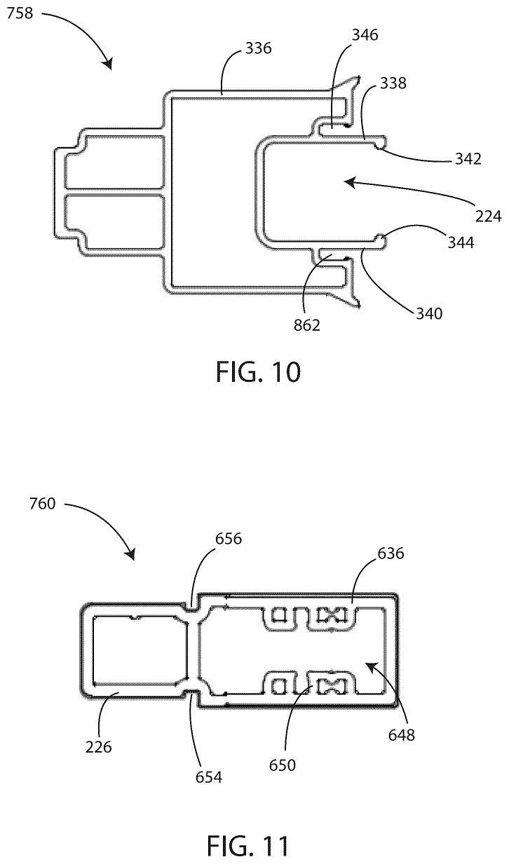

FIGS. 8-10 show cross-sectional views of various embodiments of exterior mull portions 758. FIG. 8, FIG. 9, and FIG. 10 each show a cross-sectional view of an exterior mull portion 758 according to various embodiments. The exterior mull portion 758 defines a receiving channel 224. The exterior mull portion 758 includes a body member 336. In some embodiments, the body member 336 can define an inner volume 348. In various embodiments, the body member 336 can also include one or more inner walls 350. In some embodiments, the one or more inner walls 350 can divide the inner volume 348 into a plurality of internal hollows.

The exterior mull portion 758 includes a first extension 338 and a second extension 340. The body member 336 can define a portion of the receiving channel 224, such as the distal portion or inner most portion of the receiving channel 224 (or portion closest to the exterior side of the fenestration). The first extension 338 and the second extension 340 can define a portion of the receiving channel 224, such as the distal portion or outer most portion of the receiving channel 224. In some embodiments, the first extension 338 and the second extension 340 are extensions from the body member 336 that do not enclose or form part of the inner volume 348.

In various embodiments, the first extension 338 can include a first projection 342 and the second extension 340 can include a second projection 344. When coupled with the interior mull portion 760, the projections 342, 344 can be disposed within recesses defined by the tongue 226 of the interior mull portion 760. In some embodiments, the projections 342, 344 extend into the receiving channel 224. In some embodiments, the projections 342, 344 extend into the receiving channel 224 from opposite sides of the receiving channel 224. In various embodiments, the first projection 342 can be directly across from the second projection 344, such that the first projection 342 and the second projection 344 are equal distance from the inner surface portion 230 of the receiving channel 224. In some embodiments, the projections 342, 344 extend in a direction perpendicular to a longitudinal axis of the extensions 338, 340. In some embodiments, one or both of the projections 342, 344 can be disposed at the ends of the extensions 338, 340, such as shown in FIG. 8. In some embodiments, one or both of the projections 342, 344 can be disposed at locations that are inset from the ends of the extensions 338, 340.

The exterior mull portion 758 defines a first gap 346. The first gap 346 can be external to the receiving channel 224. The first gap 346 can be defined between the first extension 338 and a portion of the body member 336. In various embodiments, the first gap 346 can allow the first extension 338 to flex or bend away from the receiving channel 224, such as to allow the tongue 226 to be inserted into the receiving channel 224.

The exterior mull portion 758 defines a second gap 862. The second gap 862 can be external to the receiving channel 224. The second gap 862 can be defined between the second extension 340 and a portion of the body member 336. In various embodiments, the second gap 862 can allow the second extension 340 to flex or bend away from the receiving channel 224, such as to allow the tongue 226 to be inserted into the receiving channel 224.

In various embodiments, the first gap 346 and the second gap 862 can be substantially the same size. In various embodiments, the first gap 346 and the second gap 862 can be substantially the same shape. In various embodiments, the first gap 346 and the second gap 862 are located on opposite sides of the receiving channel 224. In various embodiments, the first extension 338 and the second extension 340 extends at least 50% of the length of the receiving channel 224. In various embodiments, the first extension 338 and the second extension 340 extends at least 40% of the length of the receiving channel 224. In various embodiments, the first extension 338 and the second extension 340 extends at least 25% of the length of the receiving channel 224.

In various embodiments, the first extension 338 and the second extension 340 extends no more than 30% of the length of the receiving channel 224. In various embodiments, the first extension 338 and the second extension 340 extends no more than 50% of the length of the receiving channel 224. In various embodiments, the first extension 338 and the second extension 340 extends no more than 75% of the length of the receiving channel 224. In various embodiments, the first extension 338 and the second extension 340 extends no more than 90% of the length of the receiving channel 224.

In various embodiments, the first extension 338 and a second extension 340 terminate at the same distance away from a distal surface (inner surface portion 230) of the receiving channel 224. In various embodiments, the first extension 338 and a second extension 340 have the same length.

FIG. 11 shows a cross-sectional view of an interior mull portion 760 in accordance with various embodiments herein. The interior mull portion 760 can include a body member 636. The body member 636 can define an inner volume 648. The body member can further include one or more inner walls 650. The inner walls 650 can divide or separate the inner volume 648 into a plurality of internal hollows.

The interior mull portion 760 can include a tongue 226, such as a portion of the body member 636 that extends outward and is configured to be inserted into the receiving channel 224. The tongue 226 can define a first recess 654 and a second recess 656. The first recess 654 can be on the opposite side of the tongue 226 from the second recess 656. In various embodiments, the first recess 654 and the second recess 656 can each be located an equal distance away from the distal end of the tongue 226. In various embodiments, the first recess 654 can be configured to accept a first projection 342. In various embodiments, the second recess 656 can be configured to accept the second projection 344. In various embodiments, a cross-section of the interior jamb portion 222 does has at least one axis of symmetry.

### Exterior and Interior Materials and Properties

Various materials can be used to form the exterior portions 220, 758. The materials can be selected to be thermally stable, such as to control lineal expansion otherwise leading to bowing in response to temperature changes.

In various embodiments, the exterior portion can exhibit resistance to thermal expansion. For example, in various embodiments, the exterior portions can exhibit thermal expansion of less than 0.5, 0.4, 0.3, 0.2, or 0.104 inches in response to a temperature change of 90 degrees Fahrenheit over a length of 96 inches.

In various embodiments, the exterior portion can be more resistant to thermal expansion than the interior portion.

In various embodiments, the exterior portions 220, 758 can exhibit a flexural modulus of greater than 1,000,000, 1,100,000, 1,200,000, 1,300,000, 1,400,000, 1,500,000, 1,600,000, 1,700,000, 1,800,000, 1,900,000, or 2,000,000 PSI. In some embodiments, the flexural modulus can be less than 4,000,000 PSI. Flexural modulus can be measured in accordance with ASTM D790 (D790-17).

In various embodiments, the exterior portion can specifically exhibit a flexural modulus of greater than 1,600,000 PSI.

In various embodiments, the exterior portion can be stiffer than the interior portion.

In some embodiments, the exterior portion can be formed of a thermoset material while the interior portion can be formed of a thermoplastic material.

In some embodiments, the materials for the exterior portions can be painted, such as to match other exterior colors of the structure in which the fenestration assembly is being installed. In some embodiments, the exterior portion can include a cap stock layer or wrap disposed thereover. In some embodiments, the cap stock layer or wrap can be used to match other exterior colors of the structure in which the fenestration assembly is being installed.

In some embodiments, the exterior portion can be formed via a pultrusion method. In some embodiments, such as when the exterior portion is formed with a pultrusion, the exterior portion can include fiber glass (or another fiber type such as carbon or aramid fibers) and a polymer resin. The pultrusion can be formed using resin-bath pultrusion, resin-injection pultrusion, or another technique. The polymer resin can include thermoplastics and/or thermosets. Exemplary polymer resins for pultrusion can include various polyesters, viny esters, epoxies, phenolics, urethanes, and the like.

In some embodiments, the exterior portions can be formed via an extrusion method. In some embodiments, such as when the exterior portion is formed with an extrusion, the exterior portion can include a substantial proportion of glass fibers. In some embodiments, the exterior portion can include a polymer resin and at least about 5, 10, 15, 20, 25, 30, 35, or 40 wt. % glass fibers or more, or an amount falling within a range between any of the foregoing. Various polymer resins can be used herein including, but not limited to, polyvinylchloride, polypropylene or other olefins, polyethylene terephthalate (PET), glycol modified polyethylene terephthalate (PETG), polybutylene terephthalate (PBT), polyhydroxybutyrate, polylactic acid (PLA or polylactide), and the like.

Polyvinylchloride used herein can be used as a homopolymer, but can also be combined with other vinyl monomers in the manufacture of polyvinyl chloride copolymers. Such copolymers can be linear copolymers, branched copolymers, graft copolymers, random copolymers, regular repeating copolymers, block copolymers, etc. Monomers that can be combined with vinyl chloride to form vinyl chloride copolymers include a acrylonitrile; alpha-olefins such as ethylene, propylene, etc.; chlorinated monomers such as vinylidene chloride, chlorinated polyethylene, acrylate monomers such as acrylic acid, methylacrylate, methylmethacrylate, acrylamide, hydroxyethyl acrylate, and others; styrenic monomers such as styrene, alphamethyl styrene, vinyl toluene, etc.; vinyl acetate; and other commonly available ethylenically unsaturated monomer compositions.

In some embodiments, polyvinylchloride polymers having an average molecular weight (Mn) of about 40,000 to about 140,000 (90,000+/−50,000) can be used. In some embodiments, poly(vinyl chloride) polymers having an average molecular weight (Mn) of about 78,000 to about 98,000 (88,000+/−10,000) can be used.

In some embodiments, polyvinylchloride polymers used herein can have an inherent viscosity (IV—ASTM D-5225) of about 0.68 to about 1.09. In some embodiments, poly(vinyl chloride) polymers used herein can have an inherent viscosity of about 0.88 to about 0.92.

In some embodiments, polyvinylchloride polymers used herein can have a glass transition temperature (Tg) of about 70 to about 80 degrees. Poly(vinyl chloride) polymers are available from many sources under various tradenames including, but not limited to, Oxy Vinyl, Vista 5385 Resin, Shintech SE-950EG and Oxy Vinyl 225G, among others.

In some embodiments, the interior portions 222, 760 can be formed via an extrusion method. Various materials can be used to form the interior portions 222, 760. In various embodiments, the interior portion exhibits a greater degree of thermal bowing than the exterior portion.

In various embodiments, the interior portions 222, 760 can exhibit a flexural modulus of greater than 500,000, 550,000, 600,000, 650,000, 700,000, 750,000, 800,000, 850,000, 900,000, 950,000, 1,000,000, 1,100,000, 1,200,000, 1,300,000, 1,400,000, or 1,500,000 PSI. In some embodiments, the flexural modulus can be less than 4,000,000 PSI.

In various embodiments, the interior portions 222, 760 can specifically exhibit a flexural modulus of greater than about 800,000 PSI.

In various embodiments, the interior portion can exhibit resistance to thermal expansion. For example, in various embodiments, the interior portions can exhibit thermal expansion of less than 0.8, 0.7, 0.6, 0.5, 0.4, 0.3, or 0.259 inches in response to a temperature change of 10-20 degrees Fahrenheit over a length of 96 inches.

In some embodiments, the interior portions can include a polymer resin and at least 10, 15, 20, 25, 30, 35, 40, or 50 wt. % or more wood particles, or an amount falling within a range between any of the foregoing. Various polymers can be used for the polymer resin of the interior portion. By way of example, the second polymer resin can include polyvinylchloride polymers, such as those described previously herein. Interior portion polymer resins can also include Various polymer resins can be used herein including, but not limited to, polyvinylchloride, polypropylene or other olefins, polyethylene terephthalate (PET), glycol modified polyethylene terephthalate (PETG), polybutylene terephthalate (PBT), polyhydroxybutyrate, polylactic acid (PLA or polylactide), and the like.

Extrusion compositions herein can also include one or more of impact modifiers (such as acrylic impact modifiers) and processing aids. Examples of process aids include acrylic processing aids, waxes, such as paraffin wax, stearates, such as calcium stearate and glycerol monostearate, and polymeric materials, such as oxidized polyethylene. Various types of stabilizers can also be included herein such as UV stabilizers, lead, tin and mixed metal stabilizers, and the like. It is contemplated that there may be examples wherein satisfactory results may be obtained without one or more of the disclosed additives. Exemplary processing aids can include a process aid that acts as a metal release agent and possible stabilizer available under the trade designation XL-623 (paraffin, montan and fatty acid ester wax mixture) from Amerilubes, LLC of Charlotte, N.C. Calcium stearate is another suitable processing aid that can be used as a lubricant. Typical amounts for such processing aids can range from 0 to 20 wt. % based on the total weight of the composition, depending on the melt characteristics of the formulation that is desired. In some embodiments, the amount of processing aids is from 2 to 14 wt. %. In some embodiments, the amount of processing aids (as measured in parts per hundred resin) can range from 0 to 40 phr, 0.5 to 30 phr, or 0.5 to 20 phr.

Examples of other components that can be included are calcium carbonate, titanium dioxide, pigments, and the like.

### Adhesive

In various embodiments, an adhesive can be used to at least partially secure the interior components with the exterior components. The adhesive can be used to intimately bond the parts together resulting in a composite assembly. The adhesive can be selected to allow differential movements between the interior portions and the exterior portions, such as a result of different materials performing differently under similar or different conditions, such as temperature, pressure, and humidity.

In various embodiments, the adhesive can be a low modulus adhesive. Modulus refers to aspects of rigidity of the adhesive in a cured state. A low modulus adhesive is a type of adhesive that has a relatively low level of stiffness or resistance to deformation when force is applied. If the modulus is too high, it may not allow for a desirable degree of independent movement of the frame portions. However, if the modulus is too low, then it may allow for too much movement and adversely impact the strength and/or stiffness of the system. In some embodiments, the adhesive can have a modulus value of 50 to 500 PSI. In some embodiments, the adhesive can have a modulus value of 50 to 200 PSI. In some embodiments, the adhesive can have a modulus value of 75 to 125 PSI. In some embodiments herein, the adhesive can have a modulus of about 100 PSI.

In various embodiments, the adhesive can be a structural adhesive. Structural adhesives can include those capable of bearing high loads without failure. Exemplary adhesives herein can include epoxies, urethanes, acrylics, and silicones amongst others. However, in some embodiments, the adhesive is a silicone adhesive. However, in some embodiments, the adhesive is a structural silicone adhesive.

In various embodiments, the adhesive can exhibit an elongation value of 150% to 250%, or 175% to 205%, or 180% to 200%, or 185% to 190%, or about 190%.

If the adhesive is applied in too thin of a layer, it may fail. If the adhesive is applied in too thick of a layer, it may allow for too much movement and adversely impact the strength and/or stiffness of the system. In various embodiments, the adhesive can be applied in a relatively thin layer. For example, in some embodiments, the adhesive has a thickness of at least 0.01 inches and not more than 0.1 inches. In some embodiments, the adhesive has a thickness of at least 0.02 inches and not more than 0.08 inches. In various embodiments, the adhesive has a thickness of at least 0.03 inches and not more than 0.06 inches. In various embodiments, the adhesive has a thickness of at least 0.04 inches and not more than 0.05 inches.

### Composite Materials

Various embodiments herein include composite materials, such as for one or both of exterior subunit and the interior subunit of the fenestration frame. Further details about the composite materials are provided as follows. However, it will be appreciated that this is merely provided by way of example and that further variations are contemplated herein.

Composites used herein (including, for example, those used for the interior threshold subunit) can include a polymer resin. As used herein, the term “resin” shall refer to the thermoplastic polymer content of the composition. The resin portion of the composition excludes any polymer content provided by processing aids, which can also be used.

Polymer resins used with embodiments herein can include various types of polymers including, but not limited to, addition polymers, condensation polymers, natural polymers, treated polymers, and thermoplastic resins.

Thermoplastic resins herein can include addition polymers including poly alpha-olefins, polyethylene, polypropylene, poly 4-methyl-pentene-1, ethylene/vinyl copolymers, ethylene vinyl acetate copolymers, ethylene acrylic acid copolymers, ethylene methacrylate copolymers, ethyl-methylacrylate copolymers, etc.; thermoplastic propylene polymers such as polypropylene, ethylene-propylene copolymers, etc.; vinyl chloride polymers and copolymers; vinylidene chloride polymers and copolymers; polyvinyl alcohols, acrylic polymers made from acrylic acid, methacrylic acid, methylacrylate, methacrylate, acrylamide and others. Fluorocarbon resins such as polytetrafluoroethylene, polyvinylidiene fluoride, and fluorinated ethylene-propylene resins. Styrene resins such as a polystyrene, alpha-methylstyrene, high impact polystyrene acrylonitrile-butadiene-styrene polymers.

A variety of condensation polymers can also be used in the manufacture of the composites herein including nylon (polyamide) resins such as nylon 6, nylon 66, nylon 10, nylon 11, nylon 12, etc. A variety of polyester materials can be made from dibasic aliphatic and aromatic carboxylic acids and di- or triols. Representative examples include polyethylene-terephthlate, polybutylene terephthlate and others.

Polycarbonates can also be used in the polymeric resin. Such polycarbonates are long chained linear polyesters of carbonic acid and dihydric phenols typically made by reacting phosgene (COCl₂) with bisphenol A resulting in transparent, tough, dimensionally stable plastics. A variety of other condensation polymers are used including polyetherimide, polysulfone, polyethersulfone, polybenzazoles, aromatic polysulfones, polyphenylene oxides, polyether ether ketone, and others.

Poly(vinyl chloride) can be used as a homopolymer, but can also be combined with other vinyl monomers in the manufacture of polyvinyl chloride copolymers. Such copolymers can be linear copolymers, branched copolymers, graft copolymers, random copolymers, regular repeating copolymers, block copolymers, etc. Monomers that can be combined with vinyl chloride to form vinyl chloride copolymers include a acrylonitrile; alpha-olefins such as ethylene, propylene, etc.; chlorinated monomers such as vinylidene chloride, chlorinated polyethylene, acrylate monomers such as acrylic acid, methylacrylate, methylmethacrylate, acrylamide, hydroxyethyl acrylate, and others; styrenic monomers such as styrene, alphamethyl styrene, vinyl toluene, etc.; vinyl acetate; and other commonly available ethylenically unsaturated monomer compositions.

In some embodiments, poly(vinyl chloride) polymers having an average molecular weight (Mn) of about 40,000 to about 140,000 (90,000+/−50,000) can be used. In some embodiments, poly(vinyl chloride) polymers having an average molecular weight (Mn) of about 78,000 to about 98,000 (88,000+/−10,000) can be used.

In some embodiments, poly(vinyl chloride) polymers used herein can have an inherent viscosity (IV—ASTM D-5225) of about 0.68 to about 1.09. In some embodiments, poly(vinyl chloride) polymers used herein can have an inherent viscosity of about 0.88 to about 0.92.

In some embodiments, poly(vinyl chloride) polymers used herein can have a glass transition temperature (Tg) of about 70 to about 80 degrees.

Poly(vinyl chloride) polymers are available from many sources under various tradenames including, but not limited to, Oxy Vinyl, Vista 5385 Resin, Shintech SE-950EG and Oxy Vinyl 225G, among others.

In some embodiments, polypropylene having a melt flow rate (g/10 min) (ASTM D1238, 230C) of 0.5 to 75.0 can be used. In some embodiments, polypropylene having a glass transition temperature (Tg) of about 0 to about 20 degrees Celsius can be used. In some embodiments, polyethylene terephthalate (PET) having an intrinsic viscosity (IV) (DI/g) of about 0.76 to about 0.9 can be used. In some embodiments, polyethylene terephthalate (PET) having a glass transition temperature (Tg) of about 70 to about 80 degrees Celsius can be used. In some embodiments, glycol modified polyethylene terephthalate (PETG) having a glass transition temperature (Tg) of about 78-82 degrees Celsius can be used.

In some embodiments, polybutylene terephthalate (PBT) having a melt flow rate (g/10 min) (ASTM D1238, 1.2 kg, 250 C) of 100 to 130 can be used. In some embodiments, polybutylene terephthalate (PBT) having a glass transition temperature (Tg) of about 45 to about 85 degrees Celsius can be used.

Polymer blends or polymer alloys can be used herein. Such alloys can include two miscible polymers blended to form a uniform composition. A polymer alloy at equilibrium comprises a mixture of two amorphous polymers existing as a single phase of intimately mixed segments of the two macro molecular components. Miscible amorphous polymers can form glasses upon sufficient cooling and a homogeneous or miscible polymer blend can exhibit a single, composition dependent glass transition temperature (Tg). An immiscible or non-alloyed blend of polymers typically displays two or more glass transition temperatures associated with immiscible polymer phases.

Polymeric resin materials herein can retain sufficient thermoplastic properties to permit melt blending with fiber, to permit formation of extruded articles or other extrudates such as pellets, and to permit the composition material or pellet to be extruded in a thermoplastic process or in conjunction with a pultrusion process.

In some embodiments, polymer resins herein can include extrusion grade polymer resins. In some embodiments, polymer resins herein can include resins other than extrusion grade polymer resins, including, but not limited to, injection molding grade resins. Polymer resins used herein can include non-degradable polymers. Non-degradable polymers can include those that lack hydrolytically labile bonds (such as esters, orthoesters, anhydrides and amides) within the polymeric backbone. Non-degradable polymers can also include those for which degradation is not mediated at least partially by a biological system. In some embodiments, polymers that are otherwise degradable can be made to be non-degradable through the use of stabilizing agents that prevent substantial break down of the polymeric backbone.

Polymer resins herein can include those derived from renewable resources as well as those derived from non-renewable resources. Polymers derived from petroleum are generally considered to be derived from non-renewable resources. However, polymers that can be derived from biomass are generally considered to be derived from renewable resources. Polymer resins can specifically include polyesters (or biopolyesters) derived from renewable resources, including, but not limited to polyhydroxybutyrate, polylactic acid (PLA or polylactide), and the like. Such polymers can be used as homopolymer and/or copolymers including the same as subunits. Polymer resins herein can specifically include extrusion grade polymers.

Composites used herein can also include particles. Particles can include both organic and inorganic particles. Such particles can be roughly spherical, semi-spherical, block-like, flat, needle-like (acicular), plate-like (platy), flake-like (flaky), or other shape forms. Particles herein can have substantial variation. As such, the particles added to compositions in some embodiments can form a heterogeneous mixture of particles. In other embodiments, the particles can be substantially homogeneous.

In some embodiments, the particles used with compositions herein can have an aspect ratio of between about 15:1 and about 1:1. Such aspect ratios can be assessed by first taking the largest dimension of the particle (major axis) and then comparing it with the next largest dimension of the particle that is perpendicular to the major axis. In various embodiments, the particles can be, on average, from about 0.01 mm to about 8 mm in their largest dimension (or major axis or characteristic dimension).

Particles herein can include materials such as polymers, carbon, organic materials, inorganic materials, composites, or the like, and combinations of these. Polymers for the particles can include both thermoset and thermoplastic polymers. Inorganic particle materials can include, but are not limited to silicates. Inorganic particle materials can specifically include, but are not limited to, glass beads, glass bubbles, minerals such as mica and talc, and the like.

Particles herein can specifically include organic particles. Particles herein can specifically include particles comprising substantial portions of lignin, hemicellulose and cellulose (lignocellulosic materials), such as wood particles or wood flour. Wood particles can be derived from hardwoods or softwoods. In various embodiments, the wood particles can have a moisture content of less than about 8, 6, 4, or 2 percent.

In various embodiments, the wood particles can be a heterogeneous mixture of wood particles, wherein at least about 50, 60, 70, 80, 90, or 95 weight percent of the particles are 80 Mesh or larger (or 80 sieve size—corresponding to a pore size of 0.177 mm and a particle size of approximately 0.180 mm).

Other biomaterials or other organic materials may also be used as particles. As used herein, the term “biomaterial” will refer to materials of biological origin, such as wood fiber, hemp, kenaf, bamboo, rice hulls, and nutshells. More generally, other lignocellulose materials resulting from agricultural crops and their residues may also be used as particles.

In some embodiments, particles herein can include inorganic materials such as metal oxide particles or spheres, glass particles, or other like materials. These particles may be used either alone or in combination with other organic or inorganic particles.

Particles used herein can include newly synthesized or virgin materials as well as recycled or reclaimed materials or portions of recycled materials. In some embodiments, reclaim streams can be from the composition herein or from other extrusion, molding, or pultrusion compositions. As such, in some embodiments particles herein can include portions of multiple materials.

In some embodiments, the particles used herein can include a single particle type in terms of material and dimensions, and in other embodiments can include a mixture of different particle types and/or fiber dimensions. In some embodiments, the particles used herein can include a first particle type and/or size in combination with a second particle type and/or size.

In various embodiments, particles used herein can be coated with a material. By way of example, particles can be coated with a lubricant, a tie layer, or other type of compound.

The amount of the particles used in the composition can vary based on the application. In some embodiments, the amount of particles in the composition can be greater than or equal to about 1, 2, 4, 6, 8, 10, 15, 20, 25, or 30 wt. % or more (calculated based on the weight of the particles as a percent of the total weight of the extruded composition in which the particles are disposed). In some embodiments, the amount of particles in the composition can be less than or equal to about 80, 75, 70, 65, 60, 55, 50, 45, 40, 35, 30, 25, 20, 15, 10, or 5 weight percent. In some embodiments, the amount of particles can be in a range wherein each of the foregoing numbers and serve as the upper or lower bound of the range provided that the upper bound is larger than the lower bound.

Composites used herein can also include fibers. Fibers used herein can include fibers of various types and in various amounts. By way of example, fibers used in embodiments herein can include materials such as glasses, polymers, ceramics, metals, carbon, basalt, composites, or the like, and combinations of these. Exemplary glasses for use as fibers can include, but are not limited to, silicate fibers and, in particular, silica glasses, borosilicate glasses, alumino-silicate glasses, alumino-borosilicate glasses and the like. Exemplary glass fibers can also include those made from A-glass, AR-glass, D-glass, E-glass with boron, E-glass without boron, ECR glass, S-glass, T-glass, R-glass, and variants of all of these. Exemplary glass fibers include 415A-14C glass fibers, commercially available from Owens Corning. However, exemplary fibers can include cellulosic and/or lignocellulosic fibers.

Exemplary polymers for use as fibers can include, but are not limited to, both natural and synthetic polymers. Polymers for fibers can include thermosets as well as thermoplastics with relatively high melt temperatures, such as 210 degrees Celsius or higher.

Natural fibers that can be used in the invention include fibers derived from jute, flax, hemp, ramie, cotton, kapok, coconut, palm leaf, sisal, and others.

Synthetic fibers that can be used in the manufacture of the composites herein include cellulose acetate, acrylic fibers such as acrylonitrile, methylmethacrylate fibers, methylacrylate fibers, and a variety of other basic acrylic materials including homopolymers and copolymers of a variety of acrylic monomers, aramid fibers which comprise polyamides having about 85% or more of amide linkages directly attached to two aromatic rings, nylon fibers, polyvinylidene dinitryl polymers. Polyester including polyethylene terephthlate, polybutylene terephthlate, polyethylene naphthalate, RAYON, polyvinylidene chloride, spandex materials such as known segmented polyurethane thermoplastic elastomers, vinyl alcohol, and modified polyvinyl alcohol polymers and others.

Fibers used herein can include newly synthesized or virgin materials as well as recycled materials or portions of recycled materials.

In some embodiments, the material of the fibers can be organic in nature. In other embodiments, the material of the fibers can be inorganic in nature. Fibers can be carbon fibers, basalt fibers, cellulosic fibers, ligno-cellulosic fibers, silicate fibers, boron fibers, and the like. Exemplary metal fibers that can be used herein can include steel, stainless steel, aluminum, titanium, copper and others.

Fibers used herein can have various tensile strengths. Tensile strength can be measured in various ways, such as in accordance with ASTM D2101. In some embodiments, the tensile strength of fibers used herein can be greater than or equal to about 1000, 1500, 2000, 2500, or 3000 MPa. In some embodiments, the tensile strength of fibers herein can be less than about 5000 MPa.

Fibers herein can include those having various dimensions. Fibers used herein can have an average diameter greater than or equal to about 1, 2, 3, 4, 5, 10, 15, 20, 25, 30, 35, 40, 45, 50, 100, 200, 300, or 500 microns. In some embodiments, fibers used herein can have an average diameter of less than or equal to about 1000, 900, 800, 700, 600, 500, 400, 300, 200, 100, or 50 microns. In various embodiments, the average diameter of fibers used herein can be in a range wherein any of the foregoing diameters can serve as the upper or lower bound of the range, provided that the upper bound is greater than the lower bound. In some embodiments, the average diameter of the fibers used herein can be from 2 microns to 50 microns. In some embodiments, the average diameter of the fibers used herein can be from 10 microns to 20 microns.

Fibers used herein can have an average length of greater than or equal to about 0.1, 0.2, 0.4, 0.6, 0.8, 1, 2, 3, 4, 6, 8, 10, 12, 14, 16, 18, 20, 30, 40, 50, or 100 millimeters in length. In some embodiments, fibers used herein can have an average length of less than or equal to about 150, 100, 90, 80, 70, 60, 50, 40, 30 20, 10, 8, 5, 4, 3, or 2 millimeters. In various embodiments, the average length of fibers used herein can be in a range where any of the foregoing lengths can serve as the upper or lower bound of the range, provided that the upper bound is greater than the lower bound. In some embodiments, the average lengths of the fibers used herein can be from 0.2 millimeters to 10 millimeters. In some embodiments, the average lengths of the fibers used herein can be from 2 millimeters to 8 millimeters. It will be appreciated that fiber breakage typically occurs as a result of shear forces within the extruder. Therefore, the foregoing lengths can be as measured prior to compounding and/or extruding steps or after compounding and/or extruding steps such as in the finished extrudate.

Fibers herein can also be characterized by their aspect ratio, wherein the aspect ratio is the ratio of the length to the diameter. In some embodiments, fibers herein can include those having an aspect ratio of about 10,000:1 to about 1:1. In some embodiments, fibers herein can include those having an aspect ratio of about 5,000:1 to about 1:1. In some embodiments, fibers herein can include those having an aspect ratio of about 600:1 to about 2:1. In some embodiments, fibers herein can include those having an aspect ratio of about 500:1 to about 4:1. In some embodiments, fibers herein can include those having an aspect ratio of about 400:1 to about 15:1. In some embodiments, fibers herein can include those having an aspect ratio of about 350:1 to about 25:1. In some embodiments, fibers herein can include those having an aspect ratio of about 300:1 to about 50:1.

In some embodiments, the fibers used herein can include a single fiber type in terms of material and dimensions and in other embodiments can include a mixture of different fiber types and/or fiber dimensions. In some embodiments, the fibers used herein can include a first fiber type and/or size in combination with a second fiber type and/or size.

In various embodiments, fibers used herein can be coated with a material. By way of example, fibers can be coated with a lubricant, a tie layer, or other type of compound.

The amount of the fibers used in a composition (such as a first composition) can vary based on the application. In some embodiments, the amount of fibers in the composition can be greater than or equal to about 1, 2, 4, 6, 8, 10, 15, 20, 25, 30, 40, 50, 60, 70, or even 80 wt. % (calculated based on the weight of the fibers as a percent of the total weight of the extruded composition in which the fibers are disposed). In some embodiments, the amount of fibers in extruded composition can be less than or equal to about 90, 80, 75, 70, 65, 60, 55, 50, 45, 40, 35, 30, 25, 20, or 15 weight percent. In some embodiments, the amount of fibers in the extruded composition can be in a range wherein each of the foregoing numbers can serve as the upper or lower bounds of the range provided that the upper bound is larger than the lower bound.

Composites herein can also include various other components including, but not limited to, impact modifiers, process aids, stabilizers, and the like. Examples of process aids include acrylic processing aids, waxes, such as paraffin wax, stearates, such as calcium stearate and glycerol monostearate, and polymeric materials, such as oxidized polyethylene. Various types of stabilizers can also be included herein such as UV stabilizers, lead, tin and mixed metal stabilizers, and the like. Exemplary processing aids can include a process aid that acts as a metal release agent and possible stabilizer available under the trade designation XL-623 (paraffin, montan and fatty acid ester wax mixture) from Amerilubes, LLC of Charlotte, N.C. Calcium stearate is another suitable processing aid that can be used as a lubricant. Typical amounts for such processing aids can range from 0 to 20 wt. % based on the total weight of the composition, depending on the melt characteristics of the formulation that is desired. In some embodiments, the amount of processing aids is from 2 to 14 wt. %. In some embodiments, the amount of processing aids (as measured in parts per hundred resin) can range from 0 to 40 phr, 0.5 to 30 phr, or 0.5 to 20 phr.

Examples of other components that can be included are calcium carbonate, titanium dioxide, pigments, and the like.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A fenestration assembly comprising:
a fenestration frame, the fenestration frame comprising
an exterior subunit, the exterior subunit defining a receiving channel;
an interior subunit, wherein the interior subunit fits within the receiving channel, the interior subunit comprising
particles and/or fibers; and
a polymer resin.

2. The fenestration assembly of claim 1, the interior subunit further comprising a tongue.

3. The fenestration assembly of claim 2, wherein the tongue engages the receiving channel.

4. The fenestration assembly of claim 3, wherein the receiving channel surrounds the tongue on at least three sides.

5. The fenestration assembly of claim 1, the exterior subunit comprising:
a first projection; and
a second projection, wherein the first projection and the second projection extend within the receiving channel from opposite sides of the receiving channel.

6. The fenestration assembly of claim 5, the tongue comprising:
a first recess, wherein the first recess is configured to accept the first projection; and
a second recess, wherein the second recess is configured to accept the second projection.

7. The fenestration assembly of claim 1, the fenestration frame further comprising an adhesive, wherein the adhesive is disposed between a surface of the receiving channel and a surface of a distal end of a tongue, thereby coupling the tongue within the receiving channel.

8. The fenestration assembly of claim 7, wherein the adhesive is disposed between an exterior most surface of the receiving channel and a surface of an exterior most surface of the tongue.

9-11. (canceled)

12. The fenestration assembly of claim 7, wherein the adhesive has a thickness of at least 0.03 inches and not more than 0.06 inches.

13. (canceled)

14. The fenestration assembly of claim 1, the fenestration frame further comprising a connector, wherein the connector extends through a portion of the exterior subunit and into a portion of the interior subunit.

15. The fenestration assembly of claim 14, wherein the connector allows a limited degree of independent movement of the exterior subunit relative to the interior subunit.

16. The fenestration assembly of claim 14, wherein the connector extends through a lateral portion of the exterior subunit and into a lateral portion of the interior subunit.

17. (canceled)

18. The fenestration assembly of claim 1, wherein the exterior subunit exhibits less thermal expansion than the interior subunit.

19-20. (canceled)

21. The fenestration assembly of claim 1, the particles and/or fibers comprising at least 1 wt. % wood particles.

22-23. (canceled)

24. The fenestration assembly of claim 1, the particles and/or fibers comprising wood particles and glass fibers.

25. (canceled)

26. The fenestration assembly of claim 1,
wherein a proximal portion of the receiving channel is defined by a body member; and
wherein a distal portion of the receiving channel is defined between a first extension and a second extension.

27-44. (canceled)

45. The fenestration assembly of claim 1,
wherein the exterior subunit is pultrusion; and
wherein the interior subunit is an extrusion.

46. The fenestration assembly of claim 1,
wherein the exterior subunit is an extrusion;
wherein the interior subunit is an extrusion; and
wherein the interior subunit is formed with a different composition than the exterior subunit.

47. A fenestration assembly comprising:
a fenestration frame, the fenestration frame comprising
an exterior extrusion;
the exterior extrusion defining a receiving channel;
the exterior extrusion comprising
at least 30 wt. % glass fibers;
a first polymer resin;
an interior subunit, wherein the interior subunit fits within the receiving channel, the interior subunit comprising
particles and/or fibers; and
a second polymer resin.

48-58. (canceled)

59. A fenestration frame comprising:
a series of at least three dual component structural members comprising a first component and a second component;
the first component comprising
a fiber-reinforced polymeric material defining a receiving channel, the receiving channel being defined by a first side portion, a second side portion, and a base portion connecting the first side portion with the second side portion;
the second component comprising
a particulate-filled polymeric material defining a tongue portion that engages the receiving channel of the first component to combine the first component and the second component into a structural member.

60-67. (canceled)
